(19) United States
(12) Patent Application Publication
(10) Pub. No.: US 2008/0049701 A1
(43) Pub. Date: Feb. 28, 2008

(54) System and method for calculating a bandwidth requirement between two elements in a communications network

(75) Inventors: Russell B. Bellford, New Berlin, WI (US); Stuart Lynch Blackburn, San Ramon, CA (US)

Correspondence Address: SCHWEGMAN, LUNDBERG & WOESSNER, P.A., P.O. BOX 2938, MINNEAPOLIS, MN, 55402, US

(73) Assignee: SBC Knowledge Ventures, L.P.

(21) Appl. No.: 11/509,959

(22) Filed: Aug. 24, 2006

(51) Int. Cl. H04B 7/216

(52) U.S. Cl. 370/342

(57) ABSTRACT

A system and method for calculating a bandwidth requirement between two elements in a communications network are described. The method determines data stream information comprising a total number of data streams available for transmission within at least a portion of a communications network. Endpoint information is determined regarding a number of endpoints in the communications network associated with transmission stream information. Distribution information is determined wherein the distribution information is associated with transmission of the data streams to their end points. The method calculates the bandwidth between two elements in the communications network associated with a data stream demand using the data stream information, the endpoint information, and the distribution information.

### FIELD

The present disclosure relates generally to calculating a bandwidth requirement between two elements in a communications network.

### BACKGROUND

In order to recover content received from a remote source, the content is transmitted through a network via various switches to a user's content receiver, such as a television set top box (STB). Once content is received (e.g., television channel tuned), a user may watch the content in real time or record the content for later retrieval and use.

The demand for content via the network varies according to such factors as day of the week, time of day, season (e.g., Fall television lineup), etc. As the demand ebbs and flows so does the network bandwidth requirements. The network bandwidth requirements in turn determine the amount and type of infrastructure (e.g., network equipment, switches, etc.) required by a network administrator or builder to meet the current and or future bandwidth demands. Meeting these demands may include adding, removing or shifting equipment as required.

### BRIEF DESCRIPTION OF THE DRAWINGS

The present invention is pointed out with particularity in the appended claims. However, other features are described in the following detailed description in conjunction with the accompanying drawings in which:

FIG. 1 is diagram of an Internet Protocol Television (IPTV) system that may be used to provide video content by sending and receiving data packets, according to an example embodiment of the invention;

FIG. 2 is diagram of an IPTV network, according to an example embodiment of the invention;

FIG. 3 is a flow chart for calculating bandwidth requirements between two elements in a communications network, according to an example embodiment of the invention;

FIG. 4 is a graph displaying a Pareto-modeled night time viewer ship, according to an example embodiment;

FIG. 5A is a graph illustrating a confidence level calculation corresponding sensitivity based on the Pareto distribution and the number of STBs streaming data, according to an example embodiment of the invention;

FIG. 5B is a table of the sensitivity data used to generate the graph of FIG. 5A, according to an example embodiment of the invention;

FIG. 6 is a diagram of a bandwidth calculation system, according to an example embodiment; and

FIG. 7 is a diagrammatic representation of a machine to implement the method, according to an example embodiment.

### DETAILED DESCRIPTION

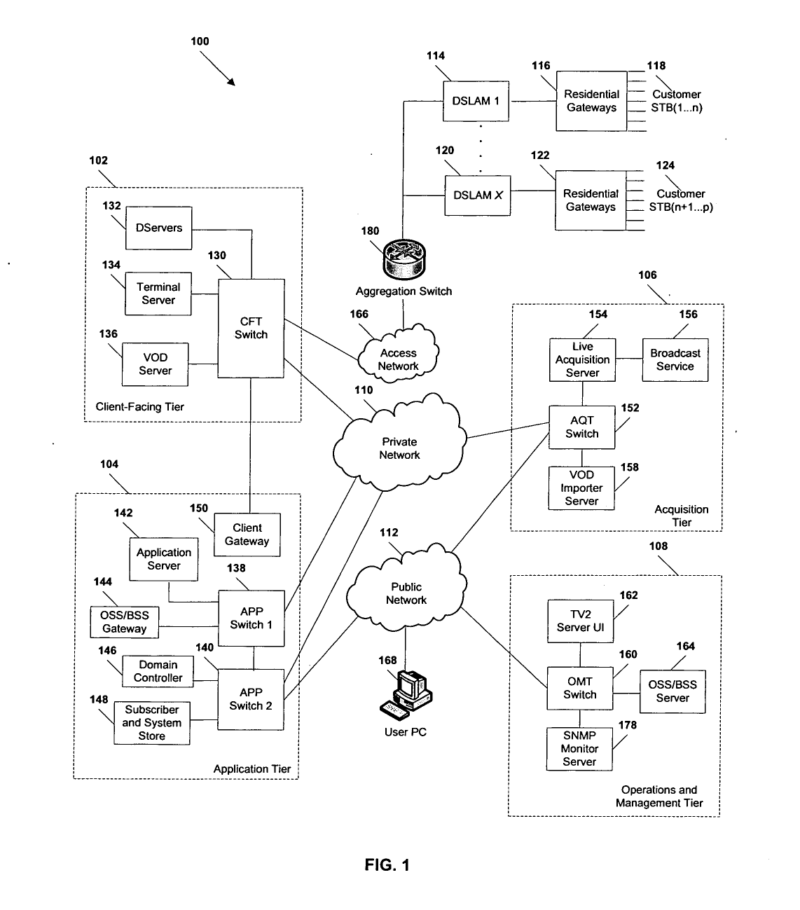

FIG. 1 illustrates an example embodiment of an Internet Protocol Television (IPTV) system 100 that may be used to provide video content by sending and receiving data packets. The IPTV system 100 may be configured to calculate a bandwidth between two network elements based on data stream information, endpoint information and distribution information associated with the IPTV system 100. In one embodiment, the calculated bandwidth may be used to determine network equipment requirements during various phases of a network system build/deployment. For example, as additional end users (e.g., set top boxes) come on-line, additional bandwidth and thus equipment may be required to satisfy the demand at a particular location in the IPTV system 100. By calculating the bandwidth prior to deployment a better approximation of equipment may be determined eliminating waste of excess bandwidth.

In one embodiment, a network administrator may periodically recalculate the bandwidth based on the methods described herein as part of a network audit and maintenance. Based on the result of the calculation (e.g., as displayed in a report), the network administrator may update and adjust equipment and processes as required. For example, the bandwidth needed for a given node may decrease while another node requires additional bandwidth. In this case, a network administrator may opt to move or shift equipment from one network location to another to satisfy the changing bandwidth demand. Additionally, periodic reports of bandwidths calculated at points throughout the IPTV system 100 may be automatically generated and communicated to the network administrator as part of an overall audit and maintenance process. An illustrated embodiment of the IPTV system 100 is discussed in detail below with respect to FIG. 1.

Returning to FIG. 1, the IPTV system 100 may include a client facing tier 102, an application tier 104, an acquisition tier 106, and an operations and management tier 108. Each tier 102, 104, 106, 108 is coupled to a private network 110; to a public network 112, such as the Internet; or to both the private network 110 and the public network 112. For example, the client-facing tier 102 may be coupled to the private network 110. Further, the application tier 104 may be coupled to the private network 110 and to the public network 112. The acquisition tier 106 may also be coupled to the private network 110 and to the public network 112. Additionally, the operations and management tier 108 may be coupled to the public network 112.

As illustrated in FIG. 1, the various tiers 102, 104, 106, 108 communicate with each other via the private network 110 and the public network 112. For instance, the client-facing tier 102 may communicate with the application tier 104 and the acquisition tier 106 via the private network 110. The application tier 104 may also communicate with the acquisition tier 106 via the private network 110. Further, the application tier 104 may communicate with the acquisition tier 106 and the operations and management tier 108 via the public network 112. Moreover, the acquisition tier 106 may communicate with the operations and management tier 108 via the public network 112. In one embodiment, elements of the application tier 104, including, but not limited to, a client gateway 150, may communicate directly with the client-facing tier 102.

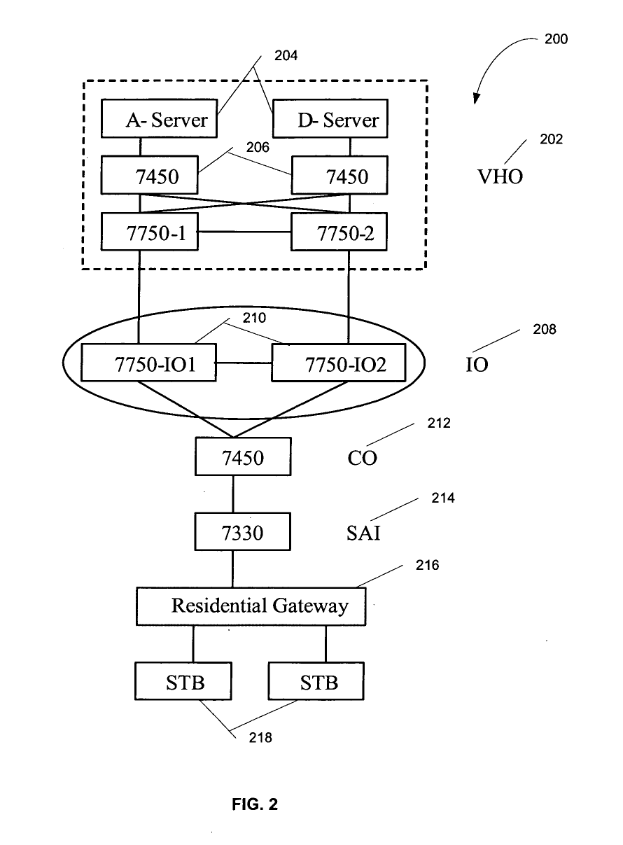

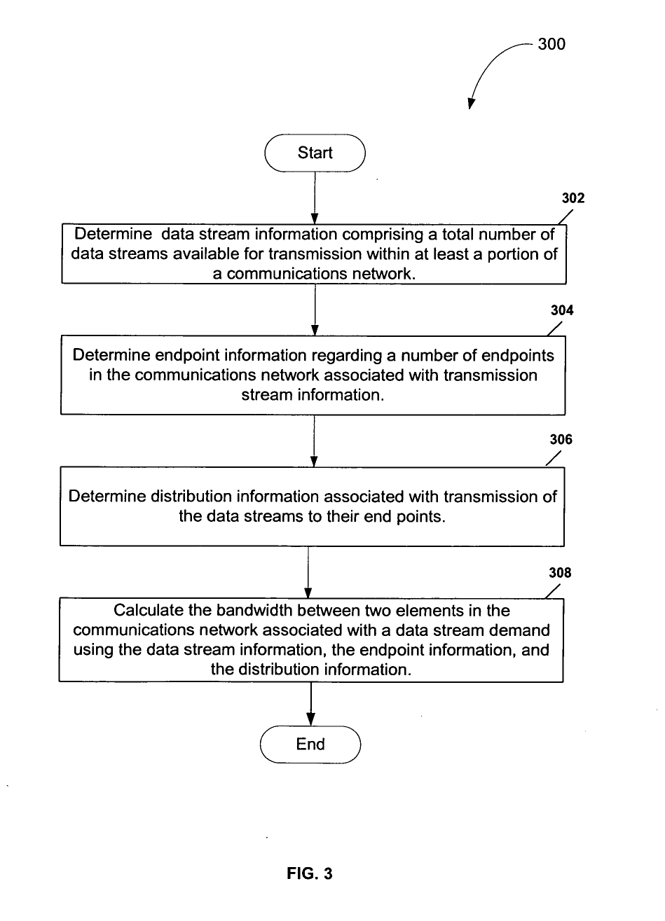

As illustrated in FIG. 1, the client-facing tier 102 may communicate with user equipment via a private access network 166, such as an Internet Protocol Television (IPTV) access network. In an example embodiment, the client-facing tier 102 may communicate with multiple network devices, such as a first representative digital subscriber line access multiplexer (DSLAM 1) 114 through a last representative digital subscriber line access multiplexer (DSLAM X) 120 via the aggregation switch 180. Representative embodiments of the aggregation switch 180 are described further with reference to FIGS. 2-3. Each DSLAM may communicate with one or more residential gateways 116, 122. Further, the residential gateways 116, 122 are each coupled to multiple customer set-top box devices 118, 124. The client-facing tier 102 may communicate with a large number of set-top boxes, such as the customer set-top boxes (STB's) 118, 124, over a wide geographic area, such as a regional area, a metropolitan area, a viewing area, or any other suitable geographic area that may be supported by networking the client-facing tier 102 to numerous set-top box devices.

In one embodiment, the IPTV system 100 may include a fiber to the neighborhood (FTTN) architecture, such that the client-facing tier 102, DSLAMs 114, 120, and the residential gateways 116, 122 communicate via fiber optic cables, and the residential gateways 116, 122 communicate with the set-top box devices 118, 124 via twisted pairs. Alternatively, a fiber to the curb system may be used, in which the residential gateways 116, 122 may be coupled to customer premises equipment (CPE), such as a DSL modem, a router, or a local area network, via fiber optic cables. Further, each CPE may be coupled to a set-top box device 118, 124. Each set-top box device 118, 124 may process data received via the private access network 166, via an IPTV software platform, such as Microsoft® TV IPTV Edition. Each set-top box device 118, 124 may be coupled to an external display device, such as a television monitor, and may communicate with a remote control device.

In a non-limiting embodiment, each set-top box device 118, 124 may receive audio, data, video, or a combination thereof, from the client-facing tier 102 via the private access network 166. The set-top box 118, 124 may output the audio, display the data, or transmit the video to an external display device. Further, the set-top box devices 118, 124 may also communicate commands received from remote control devices back to the client-facing tier 102 via the private access network 166.

In an example embodiment, the client-facing tier 102 may include a client-facing tier (CFT) switch 130 that manages communication between the client-facing tier 102 and the private access network 166 and between the client-facing tier 102 and the private network 110. As shown, the CFT switch 130 is coupled to one or more data servers or D-servers 132 that store, format and encode video content transmitted from the IPTV system 100 to the set-top box devices 118, 124, in response to user requests, such as television or video-on-demand material. The CFT switch 130 may also be coupled to a terminal server 134 that provides terminal devices with a common connection point to the private network 110. In a particular embodiment, the CFT switch 130 may also be coupled to a video-on-demand (VOD) server 136.

As illustrated in FIG. 1, the application tier 104 may communicate with both the private network 110 and the public network 112. The application tier 104 may include a first application tier (APP) switch 138 and a second APP switch 140. In a particular embodiment, the first APP switch 138 may be coupled to the second APP switch 140. The first APP switch 138 may be coupled to an application server 142 and to an OSS/BSS gateway 144. In a particular embodiment, the application server 142 may provide applications to the set-top box devices 118, 124 via the private access network 166, which enable the set-top box devices 118, 124 to provide functions, such as display, messaging, processing of IPTV data and VOD material, etc. In a particular embodiment, the OSS/BSS gateway 144 includes operation systems and support (OSS) data, as well as billing systems and support (BSS) data. In one embodiment, the OSS/BSS gateway 144 may provide or restrict access to an OSS/BSS server 164 that stores operations and billing systems data.

Further, the second APP switch 140 may be coupled to a domain controller 146 that provides web access, for example, to users via the public network 112. For example, the domain controller 146 may provide remote web access to IPTV account information via the public network 112, which users may access using their personal computers 168. The second APP switch 140 may be coupled to a subscriber and system store 148 that includes account information, such as account information that is associated with users who access the IPTV system 100 via the private network 110 or the public network 112. In an example embodiment, the application tier 104 may also include a client gateway 150 that communicates data directly with the client-facing tier 102. In this embodiment, the client gateway 150 is coupled directly to the CFT switch 130. The client gateway 150 may provide or restrict access to the private network 110 and the tiers coupled thereto.

In one embodiment, the set-top box devices 118, 124 may access the IPTV system 100 via the private access network 166, using information received from the client gateway 150. The private access network 166 may provide security for the private network 110. User devices access the client gateway 150 via the private access network 166, and the client gateway 150 may allow such devices to access the private network 110 when the devices are authenticated or verified. Similarly, the client gateway 150 may prevent unauthorized devices, such as hacker computers or stolen set-top box devices, from accessing the private network 110 by denying access to these devices beyond the private access network 166.

For example, when a set-top box device accesses the IPTV system 100 via the private access network 166, the client gateway 150 may verify subscriber information by communicating with the subscriber and system store 148 via the private network 110, the first APP switch 138, and the second APP switch 140. Further, the client gateway 150 may verify billing information and status by communicating with the OSS/BSS gateway 144 via the private network 110 and the first APP switch 138. In one embodiment, the OSS/BSS gateway 144 transmits a query via the first APP switch 138, to the second APP switch 140, and the second APP switch 140 communicates the query via the public network 112 to the OSS/BSS server 164. After the client gateway 150 confirms subscriber and/or billing information, the client gateway 150 may allow the set-top box device to access IPTV content and VOD content. If the client gateway 150 cannot verify subscriber information for the set-top box device, for example because it is connected to an unauthorized twisted pair, the client gateway 150 may block transmissions to and from the set-top box device beyond the private access network 166.

As indicated in FIG. 1, the acquisition tier 106 includes an acquisition tier (AQT) switch 152 that communicates with the private network 110. The AQT switch 152 may also communicate with the operations and management tier 108 via the public network 112. In one embodiment, the AQT switch 152 is coupled to a live acquisition server 154 that receives or acquires television or movie content, for example, from a broadcast service 156. In an example embodiment, the live acquisition server 154 transmits the television or movie content to the AQT switch 152, and the AQT switch 152 transmits the television or movie content to the CFT switch 130 via the private network 110.

Further, the television or movie content may be transmitted to the D-servers 132, where it may be encoded, formatted, stored, replicated, or otherwise manipulated or prepared for communication from the IPTV system 100 to the set-top box devices 118, 124. The CFT switch 130 may then communicate the television or movie content to the DSLAMs 114, 120 via the private access network 166. The set-top box devices 118, 124 may receive the television or movie content via the residential gateways 116, 122. In an illustrative embodiment, video or audio portions of the television or movie content may be streamed to the set-top box devices 118, 124.

In one embodiment, the AQT switch 152 may be coupled to a video-on-demand importer server 158 that stores television or movie content received at the acquisition tier 106 and communicates the stored content to the VOD server 136 at the client-facing tier 102 via the private network 110. Additionally, at the acquisition tier 106, the video-on-demand (VOD) importer server 158 may receive content from one or more VOD sources outside the IPTV system 100, such as movie studios and programmers of non-live content. The VOD importer server 158 may transmit the VOD content to the AQT switch 152, and the AQT switch 152, in turn, may communicate the material to the CFT switch 130 via the private network 110. The VOD content may be stored at one or more servers, such as the VOD server 136.

When users issue requests for VOD content via the set-top box devices 118, 124, the requests may be transmitted over the private access network 166 to the VOD server 136, via the CFT switch 130. Upon receiving such requests, the VOD server 136 may retrieve the requested VOD content and transmit the content to the set-top box devices 118, 124 across the private access network 166, via the CFT switch 130.

FIG. 1 further illustrates that the operations and management tier 108 may include an operations and management tier (OMT) switch 160 that conducts communication between the operations and management tier 108 and the public network 112. In the embodiment illustrated by FIG. 1, the OMT switch 160 is coupled to a TV2 server 162. Additionally, the OMT switch 160 may be coupled to an OSS/BSS server 164 and to a simple network management protocol (SNMP) monitor 170 that monitors network devices within or coupled to the IPTV system 100. In a particular embodiment, the OMT switch 160 may communicate with the AQT switch 152 via the public network 112.

In an example embodiment, the live acquisition server 154 may transmit the television or movie content to the AQT switch 152, and the AQT switch 152, in turn, may transmit the television or movie content to the OMT switch 160 via the public network 112. In this embodiment, the OMT switch 160 transmits the television or movie content to the TV2 server 162 for display to users accessing the user interface at the TV2 server 162. For example, a user may access the TV2 server 162 using a personal computer (PC) 168 coupled to the public network 112.

Referring now to FIG. 2, an example embodiment of a network architecture 200 is illustrated. It will be appreciated that this example embodiment is of a television network, but that the methodology may have applications in various other communication networks. The example network architecture 200 includes a Video Hub Office (VHO) 202 composed therein of servers 204 and switches 206. It will be appreciated that the number of servers and switches and their interconnection may vary among a multitude of VHO configurations.

The VHO 202 is connected to an intermediate office (IO) 208, which includes a plurality of switches 210. The IO 208 is connected to a central office (CO) 212 which is in turn connected to a serving area interface (SAI) 214. The SAI 214 is connected to a residential gateway 216 and a plurality of user set top boxes (STB) 218 are connected to the residential gateway 216. In an example embodiment, the number of connections in the network may be 20,000 lines served by the CO 212, and in which the SAI 214 serves up to 600 residential gateways. In addition, the network may include a serving terminal located between an SAI 214 and the set top boxes 218. In an example embodiment, a CO 212 will serve a small city or a town and an SAI 214 will serve a neighborhood.

It will be appreciated that this is only one example of a network architecture and the architecture may vary from network to network with the number of servers, the number of switches between the VHO and a set top box, the number of links between each of the network elements, all varying according to application specific configurations.

A data stream in the form of a video stream may be unicast or multicast through different parts of the network, between network elements. A unicast stream is an individual data stream (e.g., television channel) that is targeted to a requesting set top box (e.g., STB 218). In unicast, for example, if three set-top boxes request channel 2 content, then three unicast streams for channel 2 are generated for each requesting box from the source to the set-top box. Video on demand is an example of a unicast application. In multicast, a single data stream is transmitted between higher network elements which may be received downstream and then may be unicast by lower network elements (e.g., SAI 214) to a multitude of set-top boxes (e.g., STBs 218).

In one embodiment, data streams may be multicast to the SAI 214 then unicast to the STBs 218. However, in other embodiments, data streams may be multicast to any point or element (e.g., CO 212 or residential gateway 216) within the network architecture 200 at which point the data streams may be communicated in unicast to other network elements in route to a final destination (e.g., STBs 218).

FIG. 3 is an example embodiment of operations 300 pertaining to the calculating of a bandwidth between two elements in a communications network to satisfy a data stream demand. In various embodiments, these operations may be performed at one or more points or nodes within a network system (e.g., IPTV system 100). For example, the bandwidth may be calculated at and measured between any or all of the following: the IO 208, the CO 212, the SAI 214, and the residential gateway 216. These operations may be automatically initiated at predetermined intervals to provide a bandwidth status report to a system administrator or may be initiated by the system administrator. Once the bandwidth between any given node has been determined the system administrator may deploy additional or shift current equipment, or remove equipment as needed.

Returning to FIG. 3, at operation 302, data stream information is determined including how many data streams to transmit simultaneously between the two network elements n the communications network. In one embodiment, the data streams are television channels delivered to set-top boxes.

Next, at operation 304, endpoint information is determined including how many endpoints (e.g., STBs 218) in the communications network will receive data streams and which of data streams will pass between the two network elements if transmitted to an endpoint. In an example embodiment, one or more endpoints are associated with each set-top box. For example, each tuner capable of receiving an independent data stream within the set-top box may correspond to an endpoint.

Distribution information is determined, at operation 306, regarding the transmitting of data streams to end points, where some of the data streams will be transmitted to a plurality of endpoints, some of the data streams will be transmitted to a single endpoint and some of the data streams will not be transmitted to any endpoints.

In one example embodiment, the data stream information and the information regarding the number of endpoints in the communications network are obtained from a distribution (e.g., the Nielsen ratings by Nielsen Media Research) of television viewer ship among channels.

Thus, in an example embodiment, the distribution information is calculated by fitting the data from the Nielsen ratings for the distribution of television viewer ship among channels to a Pareto distribution. The values of the shape and scale parameters of the Pareto are chosen to provide the best fit between the Nielsen data and the model for the “most-viewed” channels for which viewer ship data is available (80% of the viewers are tuned to 20% of the available channels).

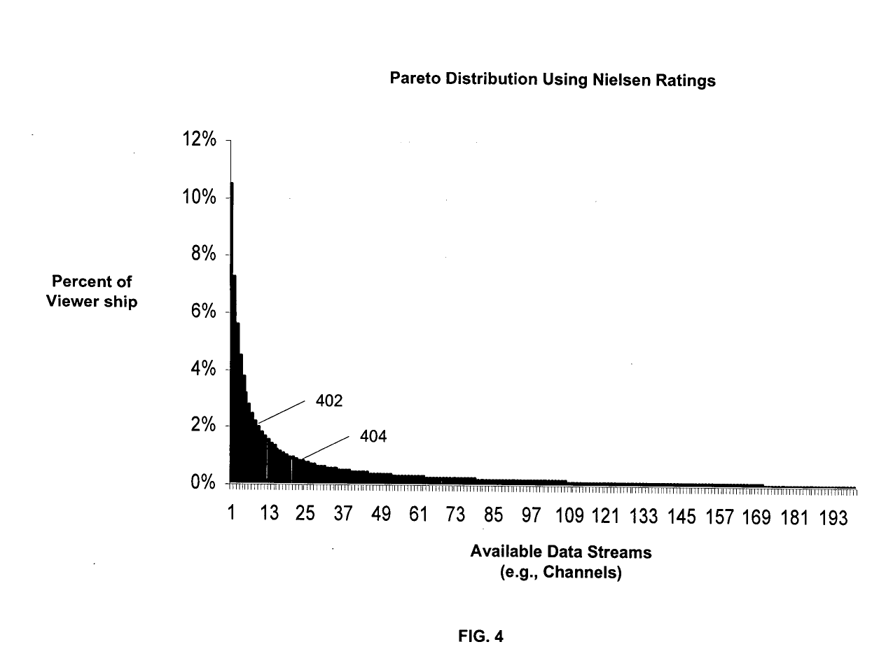

FIG. 4 is a graph illustrating a Pareto distribution model of night time viewer ship of 200 data streams, sorted from most watched to least watched. In this example embodiment, each data stream corresponds to a channel. For example, data point 402 indicates about two percent of all viewers will tune 13 data streams of all available data streams, whereas data point 404 indicates that only about one percent of the viewers will tune 25 of all available data streams. In other words, most of the available people in a given time frame (e.g., based on Nielsen stats for night time viewing) will be selecting the most popular data streams (e.g., channels) while a bulk of the data streams will have very limited or no viewer ship. Additional information with respect to FIG. 4 is discussed below.

Returning to FIG. 3, at operation 308, the data stream information, the endpoint information and the distribution information are used to calculate the bandwidth between two elements in the communications network associated with the data stream demand. As discussed above, in one embodiment, the bandwidth calculation may be used to during an initial network build out to predict a minimum amount of equipment required to satisfy the bandwidth requirement between the nodes of interest. In another embodiment, the bandwidth calculation may be used to maintain the system to meet a growing or diminishing bandwidth demand.

For example, using known number of set-top boxes (e.g., STBs 218) in a serving area interface (SAI), the number of channels available to subscribers, and distribution of viewer ship patterns among the channels, the broadcast television bandwidth requirements between the SAI (e.g., SAI 214 and the Central Office (CO) (e.g., CO 212) may be calculated.

A description of the Pareto modeling is provided below.
Xij is a binary random variable equal to one if channel i is streaming video to STBj, and zero otherwise.
i represents the broadcast TV video streams (channels) available to each set top box STB (1≦i≦200).
j represents individual STBs in an SAI (1≦j≦n).
Xᵢ is Pareto distributed (α,β) with cumulative distribution F(xᵢ) for all j, where

$$F ( {x}_{i} ) = 1 - {( \frac{β}{i + β} )}^{α}$$

F′(xi) is the truncated Pareto and this will be used to address the fact that there are a finite number of channels.

$${F}^{′} ( {x}_{i} ) = 1 - ( \frac{{F}^{′} ( {x}_{i} )}{F ( {x}_{200} )} )$$

The likelihood that channel i is not selected by any of the n STBs in an SAI will be represented by qi and is given by

qᵢ=[1−f′(xᵢ)]ⁿ

The likelihood that channel i is selected by at least one of the n STBs in an SAI will be represented by pi and is given by

pᵢ=1−qᵢ

Yn is defined as a random variable describing the number of multicast joins required between the SAI and the CO to serve all of the n video streams between the SAI and the STBs. The event that at least one of the n STBs in the SAI is streaming video from a channel i, may be viewed as a binomial random variable for each channel i. Yn is the sum of these “binomial experiments” for each channel. The expected value and variance of Yn is given by

$$E ( {Y}_{n} ) = {\sum }_{i = 1}^{200} {p}_{i} , and$$

$$V ( {Y}_{n} ) = {\sum }_{i = 1}^{200} {p}_{i} {q}_{i} .$$

The above equations allow for a closed form solution to the number of multicast joins required between the CO and the SAI for a given number of set-top boxes in the SAI.

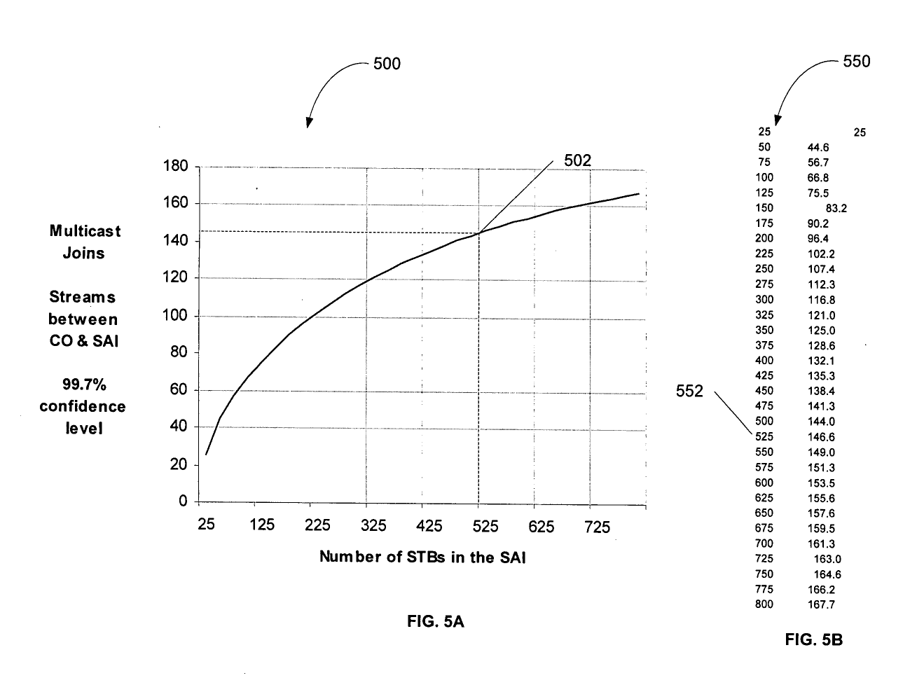

In one embodiment, a confidence level may be calculated to account for variation in the Pareto distribution model discussed above. FIG. 5A is a graph 500 illustrating a confidence level calculation corresponding sensitivity based on the Pareto distribution and the number of STBs streaming data. FIG. 5B is a table 550 of the sensitivity data used to generate the graph 500. Specifically, the graph 500 and the table 550 illustrate the relationship of the number of STBs in an SAI (e.g., STBs 218 and SAI 214) at the 99.7% confidence level for a Pareto distributed channel selection with parameters a=0.12 and β=2.2. Setting the confidence level at 99.7% accounts for variation in the model by quantifying the variation or sensitivity according to the confidence level.

For example, as illustrated in FIG. 5A at data point 502 and FIG. 5B at data point 552, for 525 set top boxes streaming data, according to the Pareto distribution shown in the graph of FIG. 4, the number of channels having at least 1 viewer at a 99.7% confidence level would be 146.6. In other words, according to an example embodiment using the Pareto distribution model discussed herein, the number of multicast joins required between two network elements, such as the CO 212 and the SAI 214, would be 146. Consequently, assuming the model was calculated based on peak bandwidth consumption, a network administrator or builder (e.g., at network build-out) may only have to provide enough equipment and service to provide bandwidth to cover the 146 multicast joins instead of providing for a maximum number, in this case for 180. It can be appreciated that because the number corresponding to data point 552 is not a whole number, whether to round to 147 or to 146 is a design choice.

Additionally, in other embodiments, additional statistical information, such as standard deviation, variance, etc., may also be factored into the number of multicast joins to use. An evaluation of these statistical elements may provide additional insight with respect to selecting the number of multicast joins (bandwidth requirements) needed to ensure adequate bandwidth during peak times.

It will also be appreciated the required number of multicast joins does not go up linearly with the number of set-top boxes. As illustrated in FIG. 5A and FIG. 5B, as the number of STBs increases the corresponding demand for bandwidth (e.g., multicast joins or data streams) “flattens” out and does not increase in a linear fashion. For example, if 600 set-top boxes required “x” multicast joins, 3000 set-top boxes would not require 5 times “x” multicast joins, but rather a lesser number.

In one embodiment, the method and operations describes above may be used for estimating bandwidth requirements for systems capable of streaming data for mosaic type features. In broadcast television mosaic includes the ability to display multiple channels for picture-in-picture viewing. For example, a subscriber may be able to configure an STB to display six channels simultaneously on a video screen.

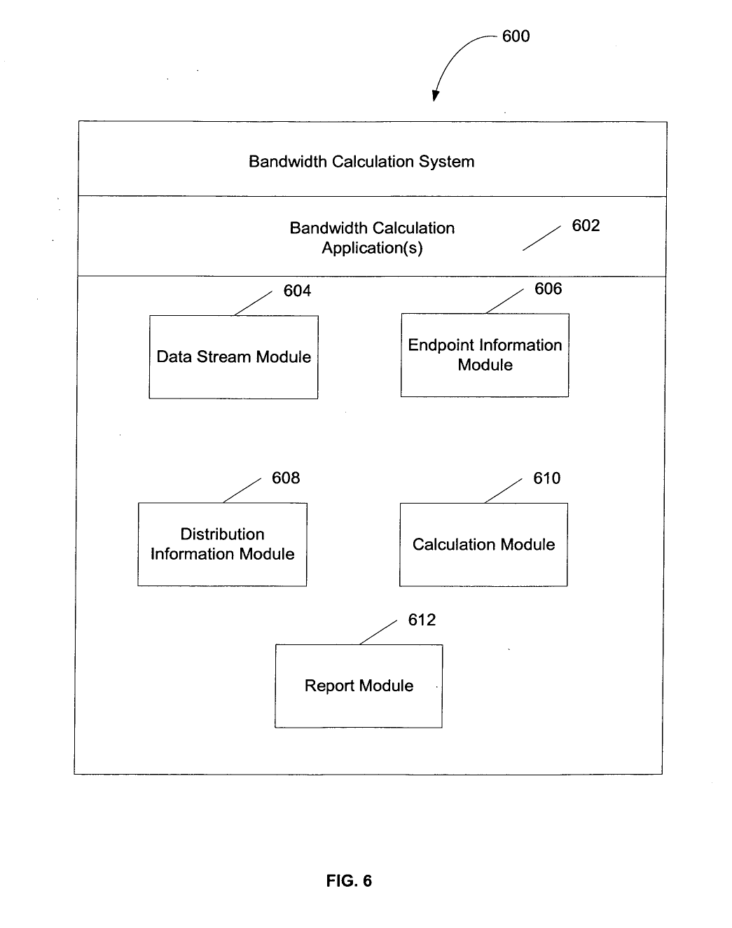

FIG. 6 is a diagram of a bandwidth calculation system 600 to implement various embodiments of methodologies discussed herein. The bandwidth calculation system 600 includes one or more bandwidth calculation applications 602, which may be utilized to carry out necessary operations to calculate a bandwidth requirement between two particular nodes in a network that uses multicast joins. In embodiment, the bandwidth calculation applications 602 includes a data stream module 604, an endpoint information module 606, a distribution information module 608, and a distribution information module 610.

In one embodiment, the data stream module 604 determines data stream information regarding a number of data streams which are required to be transmitted simultaneously between two network elements. The endpoint information module 606 determines the endpoint information regarding a number of endpoints in the communications network to which data streams may be transmitted, and which data streams will pass between the two network elements if transmitted to an endpoint. The distribution information module 608 determines distribution information being the distribution of data streams to end points where some of the data streams will be transmitted to a plurality of endpoints, some of the data streams will be transmitted to a single endpoint and some of the data streams will not be transmitted to any endpoints. The calculation module 610 uses the data stream information, the endpoint information and the distribution information to calculate a required bandwidth between the two network elements. Lastly, a report module 612 may aggregate the collected and calculated data from the other modules and generate a report that may be communicated to a user (e.g., a network administrator or builder) locally or to a remote location via a network.

In one embodiment, the graph 500, the table 550, and the corresponding confidence level may be generated by the bandwidth calculation system 600 and used by a network administrator or builder to assist in determining as accurately as possible the amount of equipment and service to provide a given node in the network (e.g., CO 212 and SAI 214). Specifically, the graph 500 and the table 550 may be included in a report generated by the report module 612 and provided to a user (e.g., a network administrator) either on site (e.g., at the CO 212 or SAI 214) or communicated remotely via a network (e.g., public network 112) over any protocol known in the art (e.g., HTML, etc.). As discussed above, the user may utilize the report to make decisions regarding building and maintaining a system (e.g., add or remove equipment and service), such as the IPTV system 100 of FIG. 1 and the network architecture 200 of FIG. 2.

In one embodiment, the report may provide bandwidth data for a multitude of nodes or sites within the network. For example, the report may indicate additional bandwidth capability may be required at the CO 212 and the SAI 214 and in one embodiment, the report may automatically suggest to the user how much and what type of equipment may be required. In another embodiment, when the report suggests an excess bandwidth the report may suggest what equipment may be removed and from where. In yet another embodiment, the report may suggest moving equipment from a node with excess bandwidth to another node with a bandwidth deficiency.

It will be appreciated that the bandwidth calculation system 600, and in particular, the bandwidth calculation applications 602 and associated modules could be implemented in various configurations and implemented on one or more computer systems within or external to the networks, nodes, and endpoints illustrated in FIG. 1 and FIG. 2.

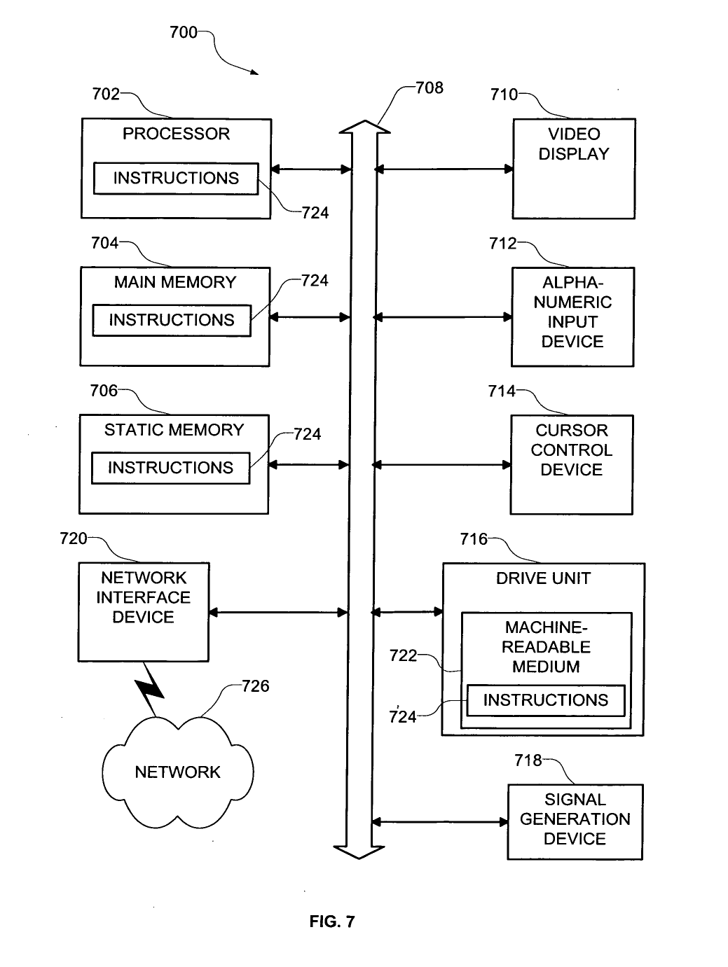

FIG. 7 shows a diagrammatic representation of machine in the example form of a computer system 700 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 includes a processor 702 (e.g., a central processing unit (CPU), a graphics processing unit (GPU) or both), a main memory 704 and a static memory 706, which communicate with each other via a bus 708. The computer system 700 may further include a video display unit 710 (e.g., a liquid crystal display (LCD) or a cathode ray tube (CRT)). The computer system 700 also includes an alphanumeric input device 712 (e.g., a keyboard), a user interface (UI) navigation device 714 (e.g., a mouse), a disk drive unit 716, a signal generation device 718 (e.g., a speaker) and a network interface device 720.

The disk drive unit 716 includes a machine-readable medium 722 on which is stored one or more sets of instructions and data structures (e.g., software 724) embodying or utilized by any one or more of the methodologies or functions described herein. The software 724 may also reside, completely or at least partially, within the main memory 704 and/or within the processor 702 during execution thereof by the computer system 700, the main memory 704 and the processor 702 also constituting machine-readable media.

The software 724 may further be transmitted or received over a network 726 via the network interface device 720 utilizing any one of a number of well-known transfer protocols (e.g., HTTP).

While the machine-readable medium 722 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention, or that is capable of storing, encoding or carrying data structures utilized by or associated with such a set of instructions. The term “machine-readable medium” shall accordingly be taken to include, but not be limited to, solid-state memories, optical and magnetic media, and carrier wave signals.

It will be appreciated that the methodology for some of the embodiments described above are based on empirical data describing customer behavior regarding television viewing patterns for the most watched channels from Nielsen data. The truncated Pareto distribution is fitted to the most watched empirical data and viewer ship is projected for the less watched channels. It may also be appreciated that other embodiments may use other empirical data pertaining to bandwidth usage, which may be fitted into a statistical model to determine a required bandwidth between network elements without departing from the scope and spirit of the methodologies discussed herein.

In embodiments using the truncated Pareto distribution in approximating viewer ship, an advantage may be in providing a more flexible model. For example, as the number of channels offered to subscribers increases, the projection of viewer ship to the additional channels may be easily modified using existing data.

In various embodiments, the methodologies discussed herein are applicable at any level of the network. This allows, for example, bandwidth trade-offs to be evaluated regarding the selection of where multicast joins should be enacted within the network.

Although an embodiment of the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A method, comprising:
determining data stream information comprising a total number of data streams available for transmission within at least a portion of a communications network;
determining endpoint information regarding a number of endpoints in the communications network associated with transmission stream information;
determining distribution information associated with transmission of the data streams to their end points; and
calculating the bandwidth between two elements in the communications network using the data stream information, the endpoint information, and the distribution information.

2. The method of claim 1, wherein determining the distribution information further includes recognizing the distribution information at least one from a group including a Pareto distribution and a Weibull distribution.

3. The method of claim 1, wherein determining the data stream information further includes recognizing the communications network as a television network, wherein the two elements are switches in that television network.

4. The method of claim 3, wherein the recognizing further includes using the switches as a central office switch and as a serving area interface switch.

5. The method of claim 3, wherein the recognizing further includes using the endpoints as set top boxes (STBs).

6. The method of claim 3, wherein the recognizing further includes corresponding each data stream between the two elements in the communications network to a television channel.

7. The method of claim 3, wherein the recognizing further includes using the data streams as picture in picture television channels.

8. The method of claim 3, wherein the calculating of the bandwidth includes calculating a number of multicast joins used to deliver a selected number of data streams to the appropriate endpoints.

9. The method of claim 1, further including:
generating a report including at least one from a group including the data stream information, the endpoint information, the distribution information, the calculated bandwidth, and a user recommendation pertaining to configuring the communications network; and
communicating the report to a user.

10. The method of claim 9, wherein the recommendation pertaining to configuring the communications network includes recommending an addition or removal at least one from a group including equipment and service associated with the bandwidth of the communications network.

11. A system, comprising:
a data stream module to determine data stream information regarding a total number of data streams available for transmission within at least a portion of a communications network;
an endpoint information module to determine endpoint information pertaining to a number of endpoints in the communications network associated with transmission stream information;
a distribution information module to determine distribution information associated with transmission of the data streams to their endpoints; and
a calculation module to use the data stream information, the endpoint information and the distribution information to calculate a bandwidth between the two network elements.

12. The system of claim 11, wherein the distribution information module is to determine the distribution information according to at least one from a group including a Pareto distribution and a Weibull distribution.

13. The system of claim 11, wherein the distribution information module further to determine the distribution information according to at least one from a group including standard deviation and variance.

14. The system of claim 11, wherein the calculation module is to calculate the bandwidth by calculating a number of multicast joins for delivering a selected number of the data streams to the appropriate endpoints.

15. The system of claim 11, wherein the communications network is a television network and the two network elements are switches in the television network.

16. A system, comprising:
data stream means for determining data stream information comprising a total number of data streams available for transmission within at least a portion of a communications network;
endpoint information means for determining endpoint information regarding a number of endpoints in the communications network associated with transmission stream information;
distribution information means for determining distribution information associated with transmission of the data streams to their end points; and
calculation means for calculating a bandwidth between two the two network elements using the data stream information, the endpoint information, and the distribution information.

17. The system of claim 16, further comprising calculation means for calculating the bandwidth by calculating a number of multicast joins for delivering a selected number of the data streams to the appropriate endpoints.

18. The system of claim 16, further comprising distribution means to fit the distribution information according to at least one from a group including Pareto distribution and a Weibull distribution.

19. The system of claim 16, further including:
a report module to generate a report including at least one from a group including the data stream information, the endpoint information, the distribution information, the calculated bandwidth, and a user recommendation pertaining to configuring the communications network; and
to communicate the report to a user.

20. The system of claim 19, wherein the report module to create the recommendation pertaining to configuring the communications network further to recommend an addition or removal at least one from a group including equipment and service associated with the bandwidth of the communications network.

21. A machine-readable medium having instructions thereon which, when executed by a machine, cause the machine to:
determine data stream information regarding a total number of data streams available for transmission within at least a portion of a communications network;
determine endpoint information pertaining to a number of endpoints in the communications network associated with transmission stream information;
determine distribution information associated with transmission of the data streams to their endpoints; and
to use the data stream information, the endpoint information and the distribution information to calculate a bandwidth between the two network elements.

22. The machine-readable medium of claim 21, wherein to determine the distribution information further includes to fit the distribution information according to at least one from a group including a Pareto distribution and a Weibull distribution.

23. The machine-readable medium of claim 21, wherein to determine the distribution information further includes to fit the distribution information according to at least one from a group including standard deviation and variance.

24. The machine-readable medium of claim 21, wherein to calculate the required bandwidth includes to calculate a number of multicast joins used to deliver a selected number of data streams to the appropriate endpoints.
